(19) United States
(12) Patent Application Publication
(10) Pub. No.: US 2026/0154266 A1
(43) Pub. Date: Jun. 4, 2026

(54) EXECUTING A RESOURCE DESCRIPTION FRAMEWORK QUERY DEFINING A SELECTOR OPERATION

(71) Applicant: Nokia Solutions and Networks Oy, Espoo (FI)

(72) Inventor: Philippe DOBBELAERE, Antwerp (BE)

(21) Appl. No.: 19/285,644

(22) Filed: Jul. 30, 2025

(30) Foreign Application Priority Data
Sep. 30, 2024 (FI) 20246172

(51) Int. Cl. G06F 16/2453

(52) U.S. Cl. CPC G06F 16/24545

(57) ABSTRACT

Embodiments describe a method comprising: receiving a Resource Description Framework query comprising at least one triple pattern comprising a predicate portion that defines a selector operation, wherein the predicate portion identifies: a data binding with primitive data that is nested within a complex data object provided by an external data source; and a foreign selector type configured to interface with the external data source; converting the RDF query to a query plan comprising the selector operation; and executing the query plan, wherein executing the selector operation comprises: identifying the foreign selector type from the predicate portion; instantiating a foreign selector; retrieving the complex data object from the external data source; fetching the primitive data from the complex data object using the foreign selector; creating data bindings with the primitive data based on the predicate portion; and returning the data bindings.

### TECHNICAL FIELD

Various example embodiments relate to a computer-implemented method, a controller, a computer program product and a computer-readable storage medium for executing a Resource Description Framework, RDF, query defining a selector operation.

### BACKGROUND

In software, queries are used to access data from a data source, for example to retrieve or manipulate data. A query is an expression formulated in a data query language that can be performed on data records of the data source. A query specifies precisely which data records are targeted. To this end, a query may be represented as one or more relational algebraic operations to be performed on the collection of data to obtain the specified data. An example of such a relational algebraic operation is a selector operation, which is defined to single out a specific subset of the data records. To execute a query, the query is usually first decomposed into such operations, which can then be executed one by one. Such a decomposition is sometimes also referred to as a query plan.

A data source uses a data model or data format to store its collection of data, such that every data record can be handled in the same way. Different data sources may use different data models, making interfacing with multiple data sources more complicated.

The Resource Description Framework, RDF, is a data model standard adopted as a World Wide Web Consortium, W3C, recommendation. In the RDF format, a data record is stored as a collection of a subject portion, a predicate portion and an object portion. Such a collection is also referred to as a triple pattern. A triple represents a directed graph comprising: 1) a node for the subject portion, 2) an arc going from the subject portion to the object portion for the predicate portion, and 3) a node for the object portion. The object portion typically holds the actual data of a certain data type, while the subject portion and predicate portion may be used for metadata. The data stored in the object portion can thus be of a variety of data types.

The RDF data model provides a single flexible format that can handle data merging between different types of data. As such, the RDF data model has facilitated an increase in heterogeneity of data types throughout interacting World Wide Web, WWW, applications.

### SUMMARY

The scope of protection sought for various embodiments of the invention is set out by the independent claims.

The embodiments and features described in this specification that do not fall within the scope of the independent claims, if any, are to be interpreted as examples useful for understanding various embodiments of the invention.

According to a first aspect, a computer-implemented method is provided. The computer-implemented method comprises:
receiving a Resource Description Framework, RDF, query comprising at least one triple pattern comprising a predicate portion that defines a selector operation, wherein the predicate portion identifies:
   a data binding with primitive data that is nested within a complex data object provided by an external data source, wherein the primitive data is of a primitive data type, and wherein the complex data object is of a complex data type; and
   a foreign selector type configured to interface with the external data source;
converting the RDF query to a query plan comprising the selector operation defined by the predicate portion; and
executing the query plan, wherein executing the selector operation comprises:
   identifying the foreign selector type from the predicate portion;
   instantiating a foreign selector of the foreign selector type;
   retrieving the complex data object from the external data source;
   fetching the primitive data from the complex data object using the foreign selector;
   creating data bindings with the primitive data in accordance with the predicate portion; and
   returning the data bindings.

The selector operation is characterised by a condition that defines how to select a subset of the queried data. The selector operation may include a conditional operator to express such a condition. This condition is defined by the predicate portion indicating a Boolean expression, e.g. using a mathematical conditional operator. The condition is expressed in terms of primitive data encapsulated within the queried data. The selector operation includes evaluation of the condition by executing the data binding with the primitive data. Data records satisfying the condition can as such be selected. Thus, the data binding is of a primitive data type and cannot be performed on the queried complex data.

The selector operation provided by the method is capable of digging into a complex data object to access the primitive data. This is done by use of the foreign selector. The foreign selector is configured to extract the primitive data from the complex data object. In other words, the foreign selector decapsulates the complex data object to retrieve the primitive data for the data binding. The foreign selector may be configured to extract the primitive data directly from the complex data object, i.e. without first converting the complex data object into an intermediate format. For example, the foreign selector may employ known specifications of the complex data type for obtaining the hidden primitive data to implement an efficient solution that isn't prone to programming errors.

Various foreign selectors may be provided, each one tailored to obtaining primitive data hidden within a corresponding complex data type. Which foreign selector is to be used is indicated in the query by the foreign selector type. The foreign selector type thus flags that primitive data within a complex data object is to be accessed. Besides this, the foreign selector type also indicates the appropriate foreign selector type that can be used to do so.

Advancements provided by the development of the RDF data model have led to issues for query execution, since data query languages were not designed to handle a variety of data types. In particular, it is challenging to execute a query with a selector operation on such heterogenous data. The selector operation needs to be able to reduce the collection of data to a subset based on a comparison condition. To do so, the selector operation needs to be able to access data values within a variety of data types.

Data query languages are usually configured to provide data bindings of primitive types and are unable to handle complex data types. This limits querying of a broad variety of data types. By providing the foreign selector, data bindings can be created with primitive data within complex data objects. This provides the method with the flexibility to handle various data types.

In addition, this flexibility is provided without altering the use of existing data query languages when there are no complex data objects. The step of converting the RDF query to a query plan can be done using any existing query conversion scheme. The information necessary to perform the primitive data extraction is hidden within the predicate. Therefore, the method does not interfere with regular query conversion. The foreign selector type can be disregarded during query conversion and becomes of interest only during query execution. There, the method introduces the invocation of the foreign selector, which performs the primitive data extraction. The complex data handling functionality is as such provided while maintaining backward compatibility.

According to further example embodiments, the RDF query is a SPARQL query.

SPARQL Protocol and RDF Query Language, SPARQL, is an RDF data query language for retrieving and manipulating data stored in or provided by a data source in the RDF format. SPARQL is a standard data query language for RDF graphs. The SPARQL query is a query expressed in the SPARQL data query language.

SPARQL mainly supports filtering expressions over primitive types and not over complex data types, except a limited number of built-in complex data types such as dateTime. The method allows using SPARQL to perform a selector operation on any complex data objects.

According to further example embodiments, the converting is performed by a SPARQL query planner.

A SPARQL query planner is a computer program configured to extract a query plan from a SPARQL query. This may be an existing SPARQL query planner. It is an advantage that no alterations need to be made to such a query planner in order to perform the method.

According to further example embodiments, the complex data type is in a serialised format.

A serialised data format is a standardised format for storing a data structure with multiple data records. Such a data format thus allows grouping of multiple data records into a single serialised data record. The process of converting data into the serialised format may be referred to as serialisation. The process of reconstructing data from the serialised format may be referred to as deserialization. When applying a serialised format, the primitive data is hidden within the stream of bits and can not directly be accessed.

According to further example embodiments, the serialised format is JavaScript Object Notation, JSON.

According to further example embodiments, the serialised format is the Extensible Markup Language, XML.

According to further example embodiments, the predicate portion of the triple pattern is a Uniform Resource Identifier, URI.

The URI may, for example, be a Uniform Resource Locator, URL. If the serialised format is JSON, the URL may be a JSON pointer. If the serialised format is XML, the URL may be an XPath.

According to further example embodiments, the URI has a first portion identifying the foreign selector type and a second portion identifying the data binding with the primitive data. Thereby, a query executer can directly take the necessary portions from the predicate without further calculations. According to further example embodiments, the first and second portions are separated.

According to further example embodiments, the external data source provides a telemetry stream transmitted by a sensor as complex data objects. The telemetry stream comprises information captured by the sensor and may be transmitted periodically.

According to further example embodiments, the external data source is a digital twin of a physical system providing properties of the physical system as complex data objects. The digital twin may mirror the behaviour of the system in real-time based on information received from sensors installed on the system.

According to further example embodiments, the query is a long running query for providing updated query results in accordance with updates in the external data source.

A trend in the field of querying is the increased use of long running queries, also referred to as long time queries, continuous queries or subscriptions. Such a long running query is a query that is regularly updated to capture changes to the data when they occur. It can be used to automatically receive real-time data updates. External data sources exist that are configured to support long running queries by providing streams with data updates, while other data sources require re-executing the query.

According to further example embodiments, the external data source is a RethinkDB database providing complex data objects.

RethinkDB is a noSQL database that supports real-time updates for long running queries. RethinkDB stores data in the JSON format and uses the data query language ReQL.

According to further example embodiments, the query is a RethinkDB changefeed.

A changefeed is defined within the context of the RethinkDB as an infinite stream of objects representing changes to the query's results as they occur.

According to a second aspect, a controller is provided comprising at least one processor and at least one memory including computer program code, the at least one memory and computer program code configured to, with the at least one processor, cause the controller to:
receive a Resource Description Framework, RDF, query comprising at least one triple pattern comprising a predicate portion that defines a selector operation, wherein the predicate portion identifies:
   a data binding with primitive data that is nested within a complex data object provided by an external data source, wherein the primitive data is of a primitive data type, and wherein the complex data object is of a complex data type; and
   a foreign selector type configured to interface with the external data source;
convert the RDF query to a query plan comprising the selector operation defined by the predicate portion; and
execute the query plan, wherein executing the selector operation comprises:
   identifying the foreign selector type from the predicate portion;
   instantiating a foreign selector of the foreign selector type;
   retrieving the complex data object from the external data source;
   fetching the primitive data from the complex data object using the foreign selector;
   creating data bindings with the primitive data in accordance with the predicate portion; and
   returning the data bindings.

The controller, also referred to as controller circuitry, according to the second aspect may provide one or more of the above-mentioned advantages.

According to a third aspect, a computer program product is provided. The computer program product comprises computer-executable instructions for performing the following steps when the program is run on a computer:
receiving a Resource Description Framework, RDF, query comprising at least one triple pattern comprising a predicate portion that defines a selector operation, wherein the predicate portion identifies:
   a data binding with primitive data that is nested within a complex data object provided by an external data source, wherein the primitive data is of a primitive data type, and wherein the complex data object is of a complex data type; and
   a foreign selector type configured to interface with the external data source;
converting the RDF query to a query plan comprising the selector operation defined by the predicate portion; and
executing the query plan, wherein executing the selector operation comprises:
   identifying the foreign selector type from the predicate portion;
   instantiating a foreign selector of the foreign selector type;
   retrieving the complex data object from the external data source;
   fetching the primitive data from the complex data object using the foreign selector;
   creating data bindings with the primitive data in accordance with the predicate portion; and
   returning the data bindings.

The computer program product according to the third aspect may provide one or more of the above-mentioned advantages.

According to a fourth aspect, a computer readable storage medium is provided. The computer readable storage medium comprises computer-executable instructions for performing the following steps when the program is run on a computer:
receiving a Resource Description Framework, RDF, query comprising at least one triple pattern comprising a predicate portion that defines a selector operation, wherein the predicate portion identifies:
   a data binding with primitive data that is nested within a complex data object provided by an external data source, wherein the primitive data is of a primitive data type, and wherein the complex data object is of a complex data type; and
   a foreign selector type configured to interface with the external data source;
converting the RDF query to a query plan comprising the selector operation defined by the predicate portion; and
executing the query plan, wherein executing the selector operation comprises:
   identifying the foreign selector type from the predicate portion;
   instantiating a foreign selector of the foreign selector type;
   retrieving the complex data object from the external data source;
   fetching the primitive data from the complex data object using the foreign selector;
   creating data bindings with the primitive data in accordance with the predicate portion; and
   returning the data bindings.

The computer readable storage medium according to the fourth aspect may provide one or more of the above-mentioned advantages.

### BRIEF DESCRIPTION OF THE DRAWINGS

Some example embodiments will now be described with reference to the accompanying drawings.

FIG. 1 shows an example embodiment of a method for executing an RDF query comprising a selector operation;

FIG. 2 shows an example embodiment of an RDF query;

FIG. 3 shows an example embodiment of a complex data object;

FIG. 4 shows an example embodiment of a query plan;

FIG. 5 shows an example embodiment of an RDF query;

FIG. 6 shows an example embodiment of a complex data object;

FIG. 7 shows an example embodiment of a query plan; and

FIG. 8 shows an example embodiment of a suitable computing system for performing one or more steps of a method according to example embodiments.

### DETAILED DESCRIPTION OF EMBODIMENT(S)

The present disclosure relates to the field of RDF data queries. An RDF data query can be executed to directly retrieve data from an RDF data source, e.g. an RDF database. An RDF data query can also be used to retrieve data from a data source not handling the RDF data model, e.g. from a digital twin or a telemetry stream configured to handle complex data objects.

A data query is expressed in a data query language, e.g. SPARQL. Other data query languages include ReQL and the Structured Query Language, SQL. SQL is a data query language used to manage data, especially in a relational database management system, RDBMS. It is particularly useful in handling structured data, i.e., data incorporating relations among entities and variables. SQL is standardized under ISO/IEC 9075.

The present disclosure relates to RDF data queries that define a relational algebraic selector operation on a data collection. A selector operation narrows the data records to be considered down to a subset of the available data records. To that end, such a selector operation may include a conditional operator, e.g. ‘smaller than’, <, ‘smaller than or equal to’, ≤, ‘equal to’, =, ‘not equal to’, ≠, ‘larger than’, >, and ‘larger than or equal to’, ≥, or another Boolean expression. A selector operation can result from a variety of statements in the query, which may depend on the data query language. For example, in SPARQL, a filter expression may define a selector operation.

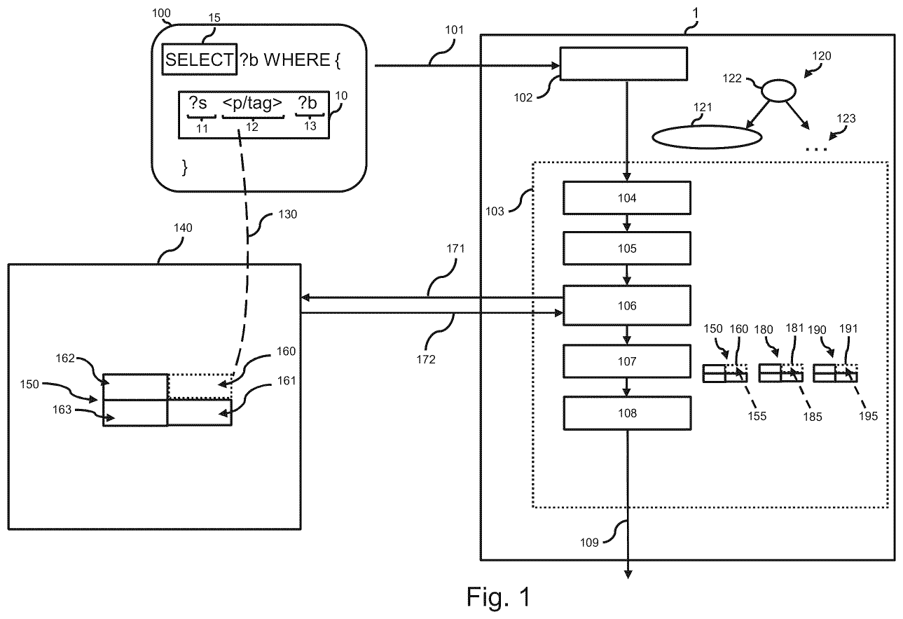

FIG. 1 illustrates a method 1 for executing an RDF query 100 according to example embodiments.

The example query 100 is a SPARQL query. The query 100 comprises a SELECT statement 15 and a triple pattern 10. A triple pattern may also be referred to as a triple or a triple statement. The triple 10 comprises a subject portion 11, also referred to as subject 11, a predicate portion 12, also referred to as predicate 12, and an object portion 13, also referred to as object 13. In accordance with the RDF data model, the subject 11 and predicate 12 can be represented by a Uniform Resource Identifier, URI. The object 13 can be a URI, a blank node or a Unicode string literal. Unicode is a standard for consistent encoding, representation and handling of text. A string is a data type for representing text. A literal is a textual representation of a value as it is written in a programming language, for example of an integer value, e.g. the number ‘3000’.

In a first step 101, the method 1 comprises receiving the RDF data query 100. The query 100 may be constructed and provided by a user for accessing data provided by an external data source 140. The external data source 140 comprises a collection of data records. Such a collection may also be referred to simply as data. The data source 140 may, for example, be a database, may provide a telemetry stream transmitted by a sensor, or may be a digital twin of a physical system providing properties of the physical system.

The data records, of which one data record 150 is illustrated in FIG. 1, are stored in any data format. Data record 150 may, for example, be in a complex data type format and comprise four nested data records 160, 161, 162, 163. To this end, the complex data type may, for example, be an array, a list, a tuple or a class object, e.g. in a serialised format such as JSON or the Extensible Markup Language, XML. The primitive data 160-163 are of a primitive data type, e.g. integer, Boolean, string et cetera. Primitive data types are the most simple data types defined by the data query language, i.e. cannot be further decomposed into simpler data types. Complex data types, on the other hand, may be constructed using one or more primitive data types.

The predicate 12 of the triple pattern 10 identifies a data binding 130 with primitive data 160. In other words, the condition to select the subset of the data as determined by the selector operation pertains to primitive data 160. A binding or data binding to an external data source 140 is a functional connection between a local object and an object provided by the external data source, indicating synchronisation of the two objects. In other words, a local object is bound to an external object if the local object is to take a value of the object of the external data source at all times and/or vice versa.

Further, the predicate 12 identifies a foreign selector type configured to interface with the external data source 140. The foreign selector type indicates which type of foreign selector can be used to access the primitive data 160, i.e. create a data binding with data 160.

In a second step 102 of the method 1, the RDF query is converted to a query plan 120 comprising the selector operation 121 defined by the predicate 12. Query conversion may also be referred to as query planning. A query conversion program may also be referred to as a query planner. The query plan 120 is a decomposition of the RDF query into a collection of relational algebraic operations, including the selector operation 121. The query plan may also include one or more rules concerning the order in which one or more of the operations are to be executed. Such a query plan may, for example, be represented by a flow diagram. A query plan can be considered as a data flow starting from one or more data sources and ending as the query result. In the present disclosure, the direction of the data flow is defined as upstream, while the direction towards the data sources is defined as downstream.

Two different types of operators may be identified in a query plan: i) a unary operator or operation, and ii) a binary operator or operation. A unary operator only has one input such as for example a projector operator, also referred to as project operation or projector operation. Another example of a unary operator is a selector operation, also referred to as selection operator. A binary operator has two inputs such as for example a join operator. Although relational algebraic operations with more than two inputs may be defined, these can always be decomposed into multiple binary operators.

A relational join operation combines two input sets of data records to a single output set. A join operation can be represented in symbols by L×R=J wherein L is the first input set, also referred to as left input set, R is the second input set, also referred to as right input set, x is the join operator, and J is the result output set. Different types of algebraic relational join operations are known in the art such as a theta-join or θ-join, an inner-join, a cross product, a left-join, and a right-join. The theta- or θ-join may be defined as the resulting set of all combinations of data records in L and R that satisfy a condition θ based on attributes of the left and/or right input set. Theta θ may be any conditional operator. An inner join may be defined as a θ-join where the conditional operator is an equality operator, e.g. ‘=’. A cross product may be defined as θ-join without condition, i.e. the condition always returns ‘true’.

A projector operation selects a subset of data attributes or data columns to be shown in the query result. Different from a selector operation, a projector operation does not exclude data records to form a subset, but rather only limits the extent to which data record details or properties are returned.

A schematic illustration of the query plan 120 is shown comprising the unary selection operation 121 and a binary join operation 122. Other operations 123 may also be part of the query plan 120.

Different query plans may be derived for a data query wherein one query plan may be optimized for memory efficiency and another query plan may be optimized for processing efficiency. Methods and derived computer programs for determining query plans from a data query are also referred to a query parser of query optimizer. A query optimizer may first convert a data query in a more formal computer interpretable representation, also referred to as an abstract syntax tree, AST. The AST is then further converted to a query plan.

Further, the method 1 comprises executing 103 the query plan 120. Execution of the selector operation 121 comprises a series of steps 104, 105, 106, 107, 108.

In the present disclosure, a computer program that executes a query plan is referred to as a query executor. Thus, steps 103-108 may be performed by a query executor. Query execution may be performed by first compiling the query plan in computer executable code and then running this code against the queried data stores. Query execution may also be performed by a query interpreter, i.e. a precompiled computer program that directly executes the query plan without further need for query specific compilation steps. Query execution may also be performed by a combination of compilation and interpretation, e.g. by applying just-in-time, JIT, compilation. In the present disclosure, a query engine refers to a computer program that has a query optimizer and a query executor. A query engine can receive a data query as input and provide the query results as output. Thus, the method 1 including steps 101-109 may be performed by a query engine.

In step 104, the foreign selector type is determined from the predicate portion 12. For example, the foreign selector type may be configured to indicate that the complex data object 150 is in the JSON format. This allows instantiating a foreign selector of the JSON type in step 105. The foreign selector is configured to retrieve data from the external data source 140 in accordance with a protocol specified by the data source 140. Thereby, it becomes possible to interact with any type of data source 140. For example, a data stream can be queried, e.g. by subscribing to a topic via a Publisher/Subscriber, Pub/Sub, system. As another example, a digital twin can be queried, e.g. using a corresponding API. As another example, a noSQL database can be queried using the appropriate query API. An example of such a noSQL database is the RethinkDB database, which can be queried using a foreign selector that implements ReQL.

It is noted that an external data source 140 may comprise different types of data, having data records of various complex data types holding primitive data to be bounded. Also, a query 100 may need to be executed for different external data sources 140. As such, one or more queries 100 may be received 101, the queries being identical except for each having a different predicate, identifying a different corresponding foreign selector type. Such queries may be sequentially executed, or may be at least partially executed in parallel. Optionally, one or more steps of the method to execute these queries may be performed only once for all the queries to save computational time and resources.

In step 106, the complex data object 150 is retrieved from the data source 140. This may be done by sending a request 171 to the data source 140, upon which data including corresponding complex data objects 172 are received from the data source 140. The received data 172 for example includes complex data 150, 180, 190 including corresponding primitive data records 160, 181, 191 respectively.

Since the data binding 130 is of a primitive data type, the binding 130 cannot be performed on the complex data objects 150, 180, 190. To overcome this, primitive data 160, 181, 191 is fetched from corresponding complex data objects 150, 180, 190 using the foreign selector in step 107.

Upon extracting the primitive data 160, 181, 191, data bindings 155, 185, 195 are created with the primitive data 160, 181, 191 in accordance with the predicate portion 12. This is done in step 108. Thereupon, the data bindings 155, 185, 195 are returned in step 109.

Upon executing the data bindings 155, 185, 195, a selection is performed that narrows the data 160, 181, 191 down to a subset of data. This subset of data consists of the data that satisfies the corresponding selector condition.

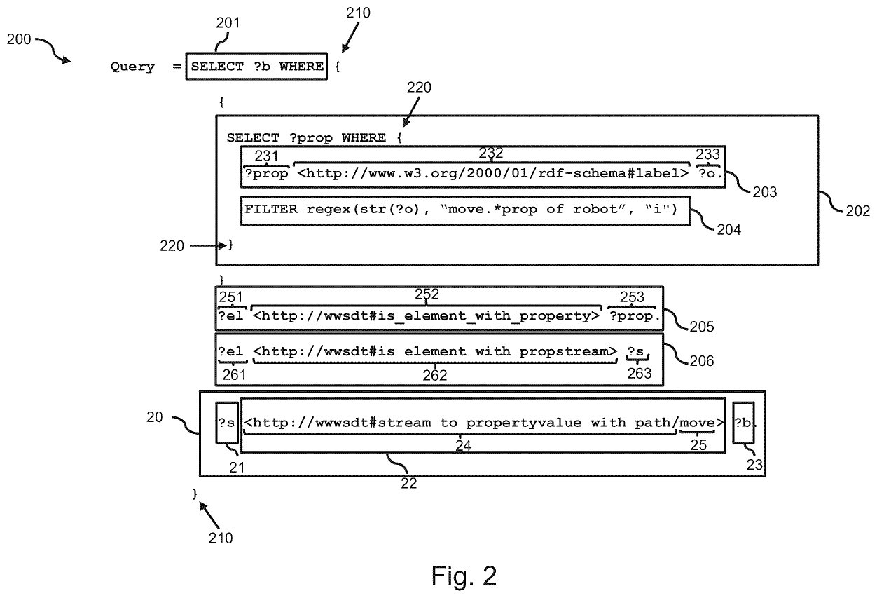

FIG. 2 shows an RDF query 200 according to example embodiments. The query 200 is a SPARQL query and comprises a SELECT statement 201.

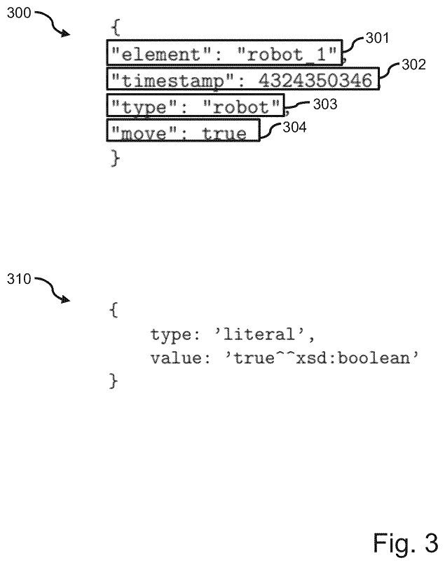

The RDF query 200 queries a digital twin of a physical system providing properties of the physical system as complex data objects. The physical system comprises robotic components. FIG. 3 illustrates such a complex data object 300 according to example embodiments.

The complex data object 300 is a data record pertaining to a robotic component of the physical system. Such a complex data object 300 may also be referred to as a property stream 300. The complex data object 300 nests four primitive data records 301, 302, 303, 304, each indicating a property. The first primitive data record 301 is named “element” and indicates the name of the robotic component as a string data type. The second primitive data record 302 is named “timestamp” and indicates a timestamp of the time at which an update from the robotic component was last received as an integer data type. The third primitive data record 303 is named “type” and indicates the robotic type of the component as a string data type. The fourth primitive data record 304 is named “move” and indicates whether or not the robotic component is moving as a Boolean data type.

In FIG. 2, the main SELECT statement 201 specifies that variable ?b will be returned for the data records that match the SELECT condition defined between outer brackets 210. The variable ?b is defined within the outer brackets 210 and comprises the object portion 23 of triple pattern 20 discussed below.

The main SELECT statement 201 comprises another SELECT statement 202. SELECT statement 202 specifies that variable ?prop is obtained for the data records matching a corresponding SELECT condition that is defined between brackets 220.

The variable ?prop is defined in triple statement 203. Triple statement 203 has the variable ?prop as subject 231, a Uniform Resource Locator, URL, as predicate 232 and a variable ?o as object 233. Triple statement 203 obtains data records via URL 232.

Thereupon, FILTER statement 204 enforces a restriction condition on the selected data records. Only those data records are retained that have a property that matches the string “move.*prop of robot”. As such, only the data records are selected that have primitive data indicating whether or not a robotic component is moving, i.e. “move” primitive data such as fourth primitive data 304. In other words, data records having some property related to robot movement are retained.

By selecting the variable ?prop, only the “move”-related property names themselves are selected by the SELECT statement 202. As such, triple statements 203, 204 combined produce properties, i.e. property names, that match with robot movement. Thus, upon execution, SELECT statement 202 finds all properties that are related to robot movement. These properties are of a primitive data type like fourth primitive data 304.

Next, triple statement 205 follows, comprising variable ?el as subject 251, a URL as predicate 252 and the variable ?prop as object 253. Triple statement 205 obtains the data records having any of the properties ?prop defined by SELECT statement 202 and stores them to variable ?el. This is done via URL 252.

Subsequently, triple statement 206 comprises the variable ?el as subject 261, a URL as predicate 262 and a variable ?s as object 263. Predicate 262 indicates a property stream of the subject 261. Via the common subject ?el, triple statement 206 collects the property stream objects of the data records that are selected in triple statement 205. These property streams are stored to the variable ?s. In other words, triple statement 206 collects the telemetry streams for the data records having a ‘moving robot’ property.

Triple statement 20 comprises the variable ?s as subject 21, a URL as predicate 22 and the variable ?b that is returned by the SELECT statement 201 as object 23. The URL 22 has a first portion 24 identifying the foreign selector type and a second portion 25 identifying the data binding with the “move” primitive data. The URL 22 is a JSON pointer, wherein the second portion 25 allows accessing the ‘move’ primitive data. The first portion 24 indicates that this is a stream selector. The special predicate 22 implements the selection down to the level of a primitive data type. The stream selector may implement use of Pub/Sub subscriptions on a Pub/Sub system provided by external data source 140. Such a Pub/Sub subscription is a subscription, i.e. long running query, to the corresponding telemetry stream. By including the second portion 25, the predicate 22 allows accessing of primitive values nested within complex data objects returned by the Pub/Sub system. The JSON pointer 22 is configured to reduce the complex data structure to an RDF literal that is then bound to the variable ?b. An example embodiment of such an RDF literal 310 for the data object 300 is shown in FIG. 3. If the query 200 is a long running query to monitor the digital twin, this conversion to an RDF literal would be done every time a digital twin property updates, e.g. every time a new data record is provided via the Pub/Sub subscription.

Thus, triple statement 20 performs the selection of the data records that have primitive data related to a moving robotic structure, e.g. primitive data 304, nested in their complex data object.

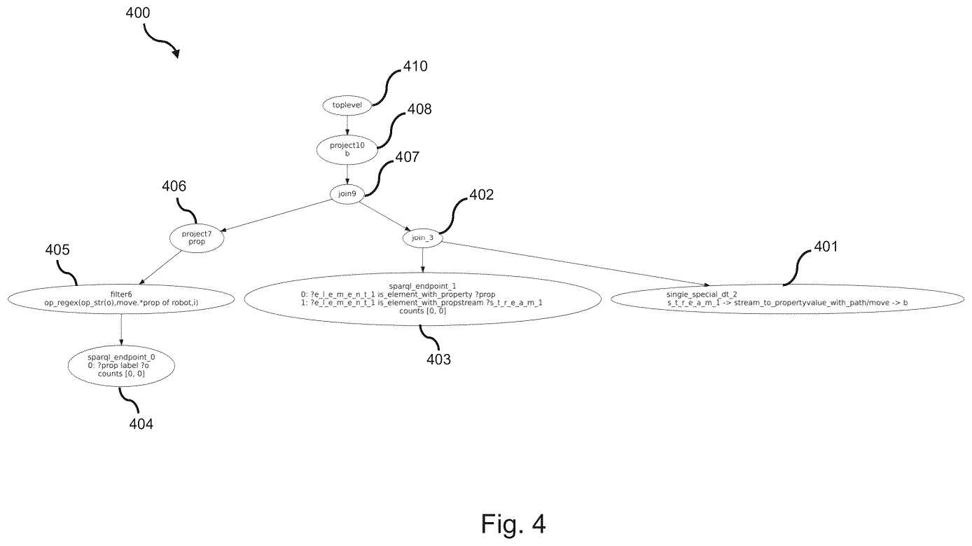

FIG. 4 shows a query plan 400 to which the RDF query 200 may be converted in step 102 according to example embodiments.

Query plan 400 comprises a selector operation 401 defined by the predicate portion 22. The selector operation 401 is characterised by a condition defining how to select a subset of the data records, i.e. by selecting the data records having the ‘move’ property.

Query plan 400 further comprises an algebra operation 404 selecting all digital twin properties. This operation 404 results from triple statement 203. Algebra operation 405 is a filter operation performing the filtering of FILTER statement 204. Further algebra operation 406 is a project operation performing the retaining of only the properties pertaining to ‘moving robot’. As such, operations 404, 405, 406 result from selecting the ?prop variable in SELECT statement 202. The ‘moving robot’ properties are further used as constraints on join operation 402, via join operation 407.

Further, query plan 400 comprises algebra operation 403, which results from triples 205, 206. Triples 205, 206 produce the elements and telemetry streams of data records having the properties identified by SELECT statement 202. The telemetry streams are applied as constraint to the selector operation 401 related to the special predicate 22. This is done via join operation 402. The selector operation 401 is configured to interface with the digital twin property infrastructure 140 using the property stream URI.

Scheduling would continue with selector operation 401 transferring the ?b binding result to the join operation 402. The join operation 402 transfers the variable ?b binding result to the join operation 407. Join operation 407 subsequently transfers the variable ?b binding result to the project operation 408.

Operation 408 is a project operation to return only the relevant primitive data values. This operation results from selecting the ?b variable in SELECT statement 201. Final operation 410 represents providing the SPARQL output.

Executing the selector operation 401 comprises:
identifying the foreign selector type from the predicate portion 22;
instantiating a foreign selector of the foreign selector type;
retrieving the complex data object from the external data source 140;
fetching the primitive data from the complex data object using the foreign selector;
creating data bindings with the primitive data in accordance with the predicate portion; and
returning the data bindings.

According to example embodiments, the instantiated relational algebraic operators 401-408 support dynamic data such as streaming data, e.g. implementing ‘changestreams’ in SPARQL. A ‘changestream’ refers to the fact that the data records on the data sources can change over time. Selector operation 401 then outputs incremental updates from these data sources. Incremental updates can comprise an addition of a set of data records and/or a deletion of a set of data records in order to reflect the current status of the data sources. Operation 410 may in such a case be a ‘changestream’ output.

Data sources may facilitate incremental updates for selector operations by supporting versioned queries, differential queries or databased change notifications. Example databases with such support are Amazon Neptune, UGent Ostrich, and RethinkDB.

RethinkDB is a distributed document-oriented database. The database stores JSON documents with dynamic schemas, and is designed to facilitate pushing real-time updates for query results to applications. RethinkDB uses the ReQL data query language. RethinkDB supports real-time change feeds. A change query returns a cursor which allows blocking or non-blocking requests to keep track of a potentially infinite stream of real-time changes.

Amazon Neptune is a managed graph database published by Amazon. com. it is used as a web service and is part of Amazon Web Services, AWS. Amazon Neptune supports RDF and various data query languages, such as SPARQL, Apache TinkerPop's Gremlin and OpenCypher.

OSTRICH is a versioned random-access triplestore developed by Ghent University, UGent.

If the data source does not provide support for incremental changes, then the selector itself is configured to detect the changes. This may for example be done by polling the data sources and generating therefrom difference results, i.e. the additions or deletions, between the successive selections.

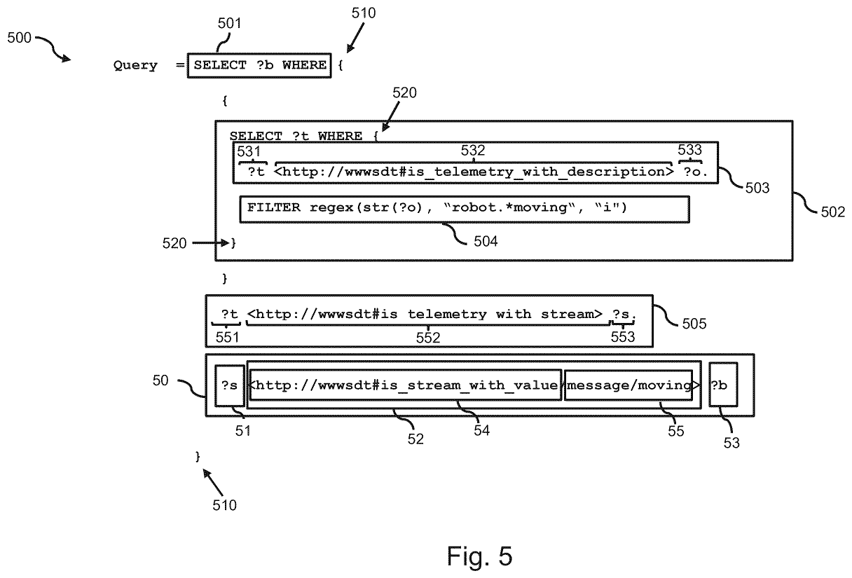

FIG. 5 shows an RDF query 500 according to example embodiments.

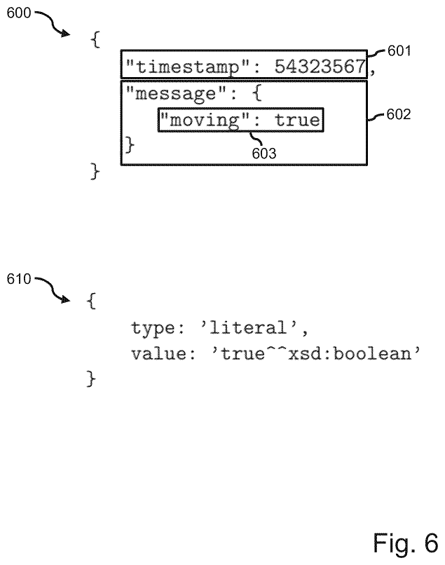

The query 500 is expressed in the SPARQL data query language. The query 500 queries an external data source providing a real-time telemetry stream in a complex data format. The stream provides information on a physical system comprising robotic components. FIG. 6 illustrates such a complex data object 600 according to example embodiments.

The complex data record 600 pertains to a robotic component of the physical system. Such a complex data object 600 may also be referred to as a telemetry stream 600. The complex data object 600 nests two primitive data records 601, 602. The first data record 601 has a property named “timestamp” and indicates a timestamp of the time at which the last message update was received as an integer data type. The second data record 602 is a complex data record 602. The second data record 602 has a property named “message” and indicates the content of the current updating message. Nested inside the ‘message’ data record 602 is a parameter name/parameter value pair. As such, each message may contain one or more updated values of parameters of the physical system. The updated parameter 603 is the ‘moving’ parameter, having the Boolean primitive data type. The ‘moving’ parameter may indicate whether or not a robotic component of the physical system is moving. The complex data object 600 indicates that the value for the ‘moving’ parameter is set to ‘True’ at timestamp ‘54323567’.

The query 500 comprises a main SELECT statement 501. SELECT statement 501 specifies that variable ?b will be returned for the data records that match the SELECT condition defined between outer brackets 510. The variable ?b is defined within the outer brackets 510 and comprises the object portion 53 of triple pattern 50 discussed below.

The main SELECT statement 501 comprises another SELECT statement 502. SELECT statement 502 specifies that variable ?t is obtained for the data records matching a corresponding SELECT condition that is defined between brackets 520.

The variable ?t is defined in triple statement 503. Triple statement 503 has the variable ?t as subject 531, a Uniform Resource Locator, URL, as predicate 532 and a variable ?o as object 533. Triple statement 503 selects the data records for which the predicate matches URL 532. In other words, the relevant data records are fetched via URL 532.

Thereupon, FILTER statement 504 enforces a restriction condition on the selected data records. Only those data records are retained that have an object that matches the string “robot.*moving”. As such, only the data messages are selected that indicate an update on whether or not a robotic component is moving, i.e. comprising ‘moving’ primitive data such as data 603.

By returning the variable ?t, SELECT statement 502 selects only the telemetry information properties related to ‘robot moving’. This is similar to SELECT statement 202, which selects the properties related to ‘robot moving’.

Next, triple statement 505 follows, comprising variable ?t as subject 551, a URL as predicate 552 and a variable ?s as object 553. Triple statement 505 collects the telemetry stream objects having the telemetry information as stored in the variable ?t. These telemetry stream objects are stored in the variable ?s.

Triple statement 50 comprises the variable ?s as subject 51, a URL as predicate 52 and the variable ?b that is returned by the SELECT statement 501 as object 53. The URL 52 has a first portion 54 identifying the foreign selector type and a second portion 55 identifying the data binding with the “moving” primitive data nested within the ‘message’ data. The URL 52 is a JSON pointer, wherein the second portion 55 allows accessing the ‘moving’ primitive data. The first portion 54 selects a particular stream. The second portion 55 comprises a first-level pointer “message” and a second-level pointer “moving”. As such, primitive data can be obtained that is nested within complex data 602, which is in its turn nested within a complex data object 600. Thus, multi-level nesting, e.g. two-level nesting as illustrated by FIGS. 5 and 6, can be handled by a method according to example embodiments.

The JSON pointer 52 is configured to reduce the complex data structure to an RDF literal that is then bound to the variable ?b. An example embodiment of such an RDF literal 610 for the data object 600 is shown in FIG. 6. Since the query 500 is a long running query to monitor the incoming telemetry information, this conversion to an RDF literal is done every time a new message is received.

Thus, triple statement 50 performs the selection of primitive data labelled “moving”, such as primitive data 603, nested within messages.

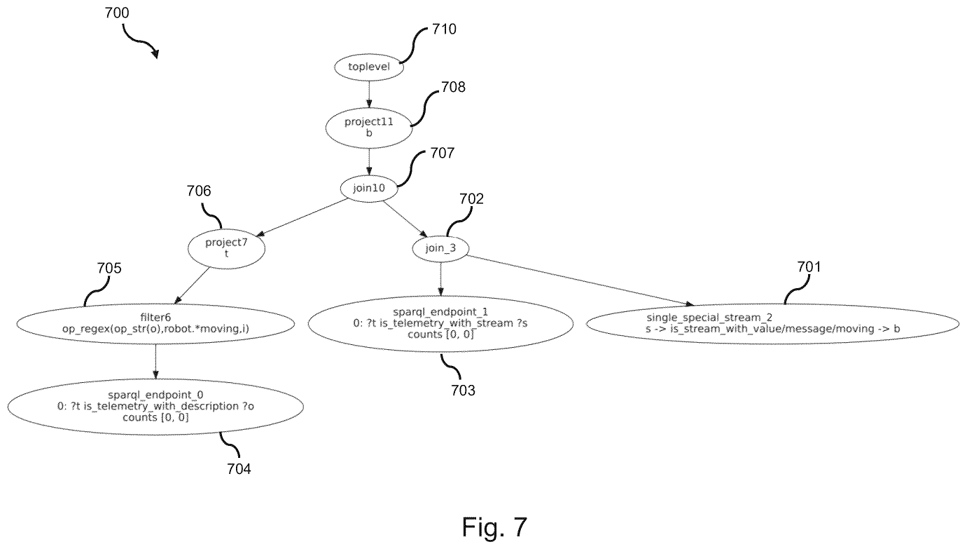

FIG. 7 shows a query plan 700 to which the RDF query 500 may be converted in step 102 according to example embodiments.

Query plan 700 comprises a selector operation 701 defined by the predicate portion 52. The selector operation 701 is characterised by a condition defining how to select a subset of the data records, by selecting data messages having the ‘moving’ property.

Query plan 700 further comprises an algebra operation 704 selecting all telemetry streams. This operation 704 results from triple statement 503. Algebra operation 705 is a filter operation performing the filtering of FILTER statement 504. Algebra operation 706 is a project operation performing the retaining of only the properties that are further necessary for data bindings downstream. As such, operations 704, 705, 706 result from selecting the ?t variable in SELECT statement 502. The messages having ‘moving robot’-related properties are further used as constraints on join operation 702, via join operation 707.

Further, query plan 700 comprises algebra operation 703, which results from triple 505. Triple 505 produces the telemetry streams of the data records that have the telemetry information identified by SELECT statement 502. This is applied as constraint to selector operation 501 related to the special predicate 52. This is done via join operation 702. The selector operation 701 is configured to interface with the telemetry stream source 140 using the telemetry stream URI.

Scheduling may continue with selector operation 701 transferring the ?b binding result to the join operation 702. The join operation 702 transfers the variable ?b binding result to the join operation 707. Join operation 707 subsequently transfers the variable ?b binding result to the project operation 708.

Operation 708 is a project operation to return only primitive telemetry data as defined by main SELECT statement 501. This operation results from selecting the ?b variable in SELECT statement 501. Final operation 710 represents providing the SPARQL output.

Executing the selector operation 701 comprises:
identifying the foreign selector type from the predicate portion 52;
instantiating a foreign selector of the foreign selector type;
retrieving the complex data object from the external data source 140;
fetching the primitive data from the complex data object using the foreign selector;
creating data bindings with the primitive data in accordance with the predicate portion; and
returning the data bindings.

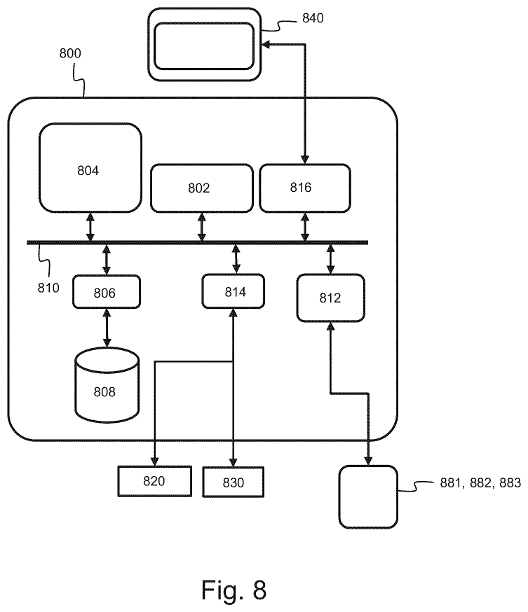

FIG. 8 shows a suitable computing system 800 enabling to implement embodiments of the method according to the first aspect. Computing system 800 may in general be formed as a suitable general-purpose computer and comprise a bus 810, a processor 802, a local memory 804, one or more optional input interfaces 814, one or more optional output interfaces 816, a communication interface 812, a storage element interface 806, and one or more storage elements 808. Bus 810 may comprise one or more conductors that permit communication among the components of the computing system 800. Processor 802 may include any type of conventional processor or microprocessor that interprets and executes programming instructions. Local memory 804 may include a random-access memory (RAM) or another type of dynamic storage device that stores information and instructions for execution by processor 802 and/or a read only memory (ROM) or another type of static storage device that stores static information and instructions for use by processor 802. Input interface 814 may comprise one or more conventional mechanisms that permit an operator or user to input information to the computing device 800, such as a keyboard 820, a mouse 830, a pen, voice recognition and/or biometric mechanisms, a camera, etc. Output interface 816 may comprise one or more conventional mechanisms that output information to the operator or user, such as a display 840, etc. Communication interface 812 may comprise any transceiver-like mechanism such as for example one or more Ethernet interfaces that enables computing system 800 to communicate with other devices and/or systems, for example with other computing devices 881, 882, 883. The communication interface 812 of computing system 800 may be connected to such another computing system by means of a local area network (LAN) or a wide area network (WAN) such as for example the internet. Storage element interface 806 may comprise a storage interface such as for example a Serial Advanced Technology Attachment (SATA) interface or a Small Computer System Interface (SCSI) for connecting bus 810 to one or more storage elements 808, such as one or more local disks, for example SATA disk drives, and control the reading and writing of data to and/or from these storage elements 808. Although the storage element(s) 808 above is/are described as a local disk, in general any other suitable computer-readable media such as a removable magnetic disk, optical storage media such as a CD or DVD,-ROM disk, solid state drives, flash memory cards, ... could be used. Computing system 800 could thus correspond to the controller circuitry according to the second aspect, the computer program product according to the third aspect, or the computer readable storage medium according to the fourth aspect.

It is noted that the present disclosure is applicable to streaming sensor data. In particular, a selector's role in a query plan, e.g. SPARQL, is to create an interface between a data source and the internal API of the query engine. With respect to the selector, the query provides enough information to select specific data in the corresponding data source, e.g. location of the source, credentials, source specific selection rules for the data, et cetera. With respect to the query engine, the selector presents the data source results in a form that is compatible with the query engine, i.e. variable bindings in case of SPARQL. The SPARQL standard itself only considers selectors into triple stores. By providing the method according to example embodiments, the range of potential data sources is expanded to any form of data source providing source results that are representable as bindings. To achieve this, the source specific selection rules are encoded into a string that can be part of an RDF predicate. Since any string can be Base64 encoded and inserted in a valid predicate, this does not pose a vital restriction. Application has been demonstrated for noSQL databases such as RethinkDB, for telemetry streams, and for digital twin properties. It is also possible to encode an SQL query with Base64 into a predicate, thereby connecting a SQL database to a SPARQL query engine.

Depending on the available features provided by the data source, querying is envisaged by extending the SPARQL standard with selectors into other data sources, but still using SPARQL BGP filter semantics. On the other hand, querying is envisaged by fully embedding of non-SPARQL query languages, i.e. going beyond SPARQL semantics, inside SPARQL query predicates. The present disclosure allows a flexible solution covering a continuum between these approaches and therefore provides some advantages of both. Such an advantage is to provide querying to any data source without having to amend the SPARQL standard. On the other hand, an advantage is to provide an efficient solution being limited error-prone. For example, example embodiments may allow querying of federated, distributed data sources with a standards compliant query language that supports semantics. Further, example embodiments may adapt data source query API's to a SPARQL engine, while allowing data changes to ripple through into updated results. Further, example embodiment may allow the use of external query languages embedded inside SPARQL predicates, and consequently, the execution of that embedded external query in the external database engine, when those external query languages would be more efficient to use compared to using simple selectors into the external data source with the heavy lifting done inside the SPARQL query plan.

A query plan according to example embodiments may be executed as a dataflow on a dataflow platform, for example World Wide Stream, WWS. Such a query plan could also be run on other query engine architectures. Query plan execution may be facilitated by constraint propagation according to example embodiments.

It is noted that a method according to example embodiments enables a developer to use a familiar query language, e.g. SPARQL, without being fully aware of the underlying data stream processing platform. A query language may be chosen that is convenient to handle Linked Open Data scenarios. In addition, this allows use of a query environment that is able to handle source federation and distributed querying in an efficient manner.

As used in this application, the term “circuitry” may refer to one or more or all of the following:
(a) hardware-only circuit implementations such as implementations in only analog and/or digital circuitry and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and/or processor(s), such as microprocessor(s) or a portion of a microprocessor(s), that requires software (e.g. firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular network device, or other computing or network device.

Although the present invention has been illustrated by reference to specific embodiments, it will be apparent to those skilled in the art that the invention is not limited to the details of the foregoing illustrative embodiments, and that the present invention may be embodied with various changes and modifications without departing from the scope thereof. The present embodiments are therefore to be considered in all respects as illustrative and not restrictive, the scope of the invention being indicated by the appended claims rather than by the foregoing description, and all changes which come within the scope of the claims are therefore intended to be embraced therein.

It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

1. A computer-implemented method comprising:
receiving a Resource Description Framework, RDF, query comprising at least one triple pattern comprising a predicate portion that defines a selector operation, wherein the predicate portion identifies:
a data binding with primitive data that is nested within a complex data object provided by an external data source, wherein the primitive data is of a primitive data type, and wherein the complex data object is of a complex data type; and
a foreign selector type configured to interface with the external data source;
converting the RDF query to a query plan comprising the selector operation defined by the predicate portion; and
executing the query plan, wherein executing the selector operation comprises:
identifying the foreign selector type from the predicate portion;
instantiating a foreign selector of the foreign selector type;
retrieving the complex data object from the external data source;
fetching the primitive data from the complex data object using the foreign selector;
creating data bindings with the primitive data in accordance with the predicate portion; and
returning the data bindings.

2. The method according to claim 1, wherein the RDF query is a SPARQL query.

3. The method according to claim 2, wherein the converting is performed by a SPARQL query planner.

4. The method according to claim 1, wherein the complex data type is in a serialised format.

5. The method according to claim 4, wherein the serialised format is JavaScript Object Notation, JSON.

6. The method according to claim 1, wherein the predicate portion of the triple pattern is a Uniform Resource Identifier, URI.

7. The method according to claim 6, wherein the URI has a first portion identifying the foreign selector type and a second portion identifying the data binding with the primitive data.

8. The method according to claim 1, wherein the external data source provides a telemetry stream transmitted by a sensor as complex data objects.

9. The method according to claim 1, wherein the external data source is a digital twin of a physical system providing properties of the physical system as complex data objects.

10. The method according to claim 1, wherein the query is a long running query for providing updated query results in accordance with updates in the external data source.

11. The method according to claim 1, wherein the external data source is a RethinkDB database providing complex data objects.

12. The method according to claim 10 wherein the query is a RethinkDB changefeed.

13. An apparatus comprising at least one processor and at least one memory including computer program code, the at least one memory and computer program code configured to, with the at least one processor, cause the apparatus to:
receive a Resource Description Framework, RDF, query comprising at least one triple pattern comprising a predicate portion that defines a selector operation, wherein the predicate portion identifies:
a data binding with primitive data that is nested within a complex data object provided by an external data source, wherein the primitive data is of a primitive data type, and wherein the complex data object is of a complex data type; and
a foreign selector type configured to interface with the external data source;
convert the RDF query to a query plan comprising the selector operation defined by the predicate portion; and
execute the query plan, wherein executing the selector operation comprises:
identifying the foreign selector type from the predicate portion;
instantiating a foreign selector of the foreign selector type;
retrieving the complex data object from the external data source;
fetching the primitive data from the complex data object using the foreign selector;
creating data bindings with the primitive data in accordance with the predicate portion; and
returning the data bindings.

14. A computer readable storage medium comprising computer-executable instructions for performing the following when the program is run on a computer:
receiving a Resource Description Framework, RDF, query comprising at least one triple pattern comprising a predicate portion that defines a selector operation, wherein the predicate portion identifies:
a data binding with primitive data that is nested within a complex data object provided by an external data source, wherein the primitive data is of a primitive data type, and wherein the complex data object is of a complex data type; and
a foreign selector type configured to interface with the external data source;
converting the RDF query to a query plan comprising the selector operation defined by the predicate portion; and
executing the query plan, wherein executing the selector operation comprises:
identifying the foreign selector type from the predicate portion;
instantiating a foreign selector of the foreign selector type;
retrieving the complex data object from the external data source;
fetching the primitive data from the complex data object using the foreign selector;
creating data bindings with the primitive data in accordance with the predicate portion; and
returning the data bindings.
